(19) United States
(12) Patent Application Publication
(10) Pub. No.: US 2003/0216950 A1
(43) Pub. Date: Nov. 20, 2003

(54) System and method for production after receiving a purchase order

(76) Inventor: Chun-Chen Chen, Shindian City (TW)

Correspondence Address: RABIN & CHAMPAGNE, PC, 1101 14TH STREET, NW, SUITE 500, WASHINGTON, DC, 20005, US

(21) Appl. No.: 10/318,168

(22) Filed: Dec. 13, 2002

(30) Foreign Application Priority Data
May 20, 2002 (TW) 091110580

(51) Int. Cl. G06F 17/60

(52) U.S. Cl. 705/8; 705/1

(57) ABSTRACT

A system for systematic production of information products comprises an order receiving system for receiving customers' orders, a converting management program for converting the information of the customer orders into the data requested by a production line and an assembling production line equipped with at least one storage rack, wherein the storage rack has a plurality of storage spaces for storing the parts of the information products and each storage space is equipped with an indicating device. The assembling production line is coupled with a control system for responding to the data converted from the converting management program by driving the indicating devices to show the locations of the parts on the rack for assembling the information products. The converting management program is periodically executed in a fixed time period set by the system to convert the information of the customer orders into the data of a production order used by the assembling production line. This system for systematic production can effectively enhance the process flow of manufacture of the information products.

This application incorporates by reference of Taiwan application Serial No. 091110580, filed May 20, 2002.

### BACKGROUND OF THE INVENTION

1. Field of the Invention

The present invention relates to a system and method for production, and more particularly, the present invention relates to a system and systematic method for production after receiving a purchase order, suitable for applications in the production modes of build-to-order (BTO) and configure-to-order (CTO).

2. Description of Related Art

In recent years, as the technology with respect to the Internet has been well developed, the technology of the sale operation mode of e-business is to be developed as well. The sale operation mode uses the Internet to provide a service to the customers to order the commercial products. In addition, it further provides the service to the customers with the customized products by a CTO manner. Taking the personal computer as an example, the customers can freely select any hardware peripherals or software to satisfy the individual customer's need. For example, customer A may select a 30 G-byte hard disk drive (HDD), but customer B may select a 40 G-byte hard disk drive(HDD). However, the conventional production mode is not capable to satisfy the requirements of this kind of sale operation mode.

The conventional production mode is based on the marketing information to predict the market requirements of the products. Accordingly, the products are produced with limited fixed configurations for the market beforehand in a mass scale. The products are stored in the warehouse and distributed according to the customers' orders. It often occurs for this kind of operation mode that the products are not fully satisfied the customers' requirements and become the leftover products. Furthermore, the products may be in short of supply and cannot be provided to the customers on the right time. In addition, since the production of products with a fixed configuration is usually made in a batch, when it is necessary to produce a product with a different configuration, the production line is needed to be changed for the different parts of the products.

Furthermore, in this conventional production mode, based on the prediction information of the business management unit or the orders from the customers, the requests for the products are then sent to the production unit. The production unit converts the request information of the products into the data of production order needed by the assembling production line, that is, into the information of needed product parts for production. The on-line operator will base on the information of production order to pick up the needed product parts and start to assemble the products. In this manner, the whole process flow is dispersing but also not continuously systematic operation. In addition, it needs to repeatedly process the data from customer orders into production orders and thus, the errors are inevitable.

When the sale volume of the product has changed to a small quantity but with various configurations thereof, especially the products are manufactured in buil-to order mode or in configuration-to-order mode, the conventional production process flow can not fully satisfy the requirements from the various customers' orders. Therefore, it demands a systematic production flow to effectively process the various customers' requirements on the products.

### SUMMARY OF THE INVENTION

It is therefore an object of the present invention to provide a system for systematic production of information products. The present system comprises an order receiving system for receiving customer orders, a converting management program for converting the information of the customer orders into the data requested by a production line, and an assembling production line equipped with at least one storage rack and coupled with a control system for responding to the data converted from the converting management program by driving an indicating devices to show the locations of the parts on the rack for assembling the information products. The storage rack equipped on the assemble line has a plurality of storage spaces for storing the parts of the information products and each storage space is equipped with an indicating device. The present system can effectively process the various customers' requirements on the products.

It is another object of the present invention to provide a method for systematic production of information products. The present method comprises the steps of receiving the customer orders and storing the same in a database management system, wherein each order is assigned a unique order number, and converting the information of the customer orders into the data requested by a production line by a converting management program. The converting management program will mark the converted customer orders after the same has been converted. The present invention uses a converting management program to automatically convert the information of the customer order into the information requested by a production order for the assembling production line. As a result, the present process is effectively simplified and improved the efficiency in processing the customer order.

Furthermore, the present invention uses the same production line for assembling the products with various configurations requested by the customers without changing the production line.

### BRIEF DESCRIPTION OF DRAWINGS

The invention can be more fully understood by reading the following detailed description of the preferred embodiments, with reference made to the accompanying drawings, wherein:

FIG. 1 is a flow diagram, schematically illustrating the process flow of a system for systematic production, according to a preferred embodiment of the present invention;

FIG. 2 is a flow diagram, schematically illustrating the process flow of the converting management program to convert the information of the customer order into the data of a production order needed by the assembly line, according to the preferred embodiment of the present invention; and

FIG. 3 is a flow diagram, schematically illustrating the process flow of the control system for responding to the data converted from the converting management program by driving an indicating device to show the locations of the parts on the rack for assembling the information products, according to the preferred embodiment of the present invention.

### DETAILED DESCRIPTION OF PREFERRED EMBODIMENTS

In the following description, a preferred embodiment of the present invention is provided as an example. The preferred embodiment is directed to a production mode to satisfy the requirements of the business to customer (B2C) e-business mode, that is the configuration-to-order mode, to sell products to the customers.

In this preferred embodiment of the present invention, the system for systematic production includes at least an order receiving system, a converting management program, and an assembling production line equipped with at least one storage rack and coupled with a control system for responding to the data converted from the converting management program by driving an indicating device to show the locations of the parts on the rack for assembling the information products. The present system for systematic production uses a database management system (DBMS) to store the data for the whole system, including the customer order information for the order receiving system, the converting information for the production order for the assembling production line and for the control system, and the information of the product parts used by the control system for picking out the part items. In this preferred embodiment, the database is a type of relational database management system (RDBMS), such as the products of MS SQL SERVER, ORACLE, and the likes.

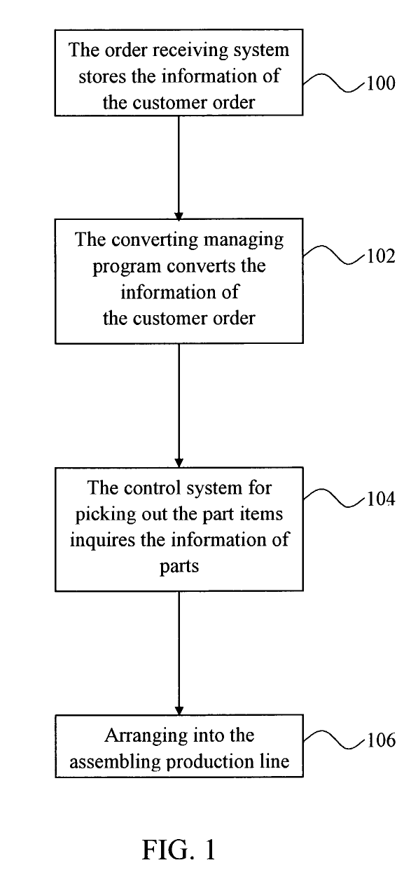

When a customer enters the order receiving system on the internet, the customer can directly use the interface provided by the order receiving system for the transaction. The order receiving system provides an interface for the customer to buy the product according to the desired product configuration. The customer can select the quality of the products, the peripherals of the products and the like based on his personal preference. After the customer completes the order and the payment, the order information, such as the quantity and the needed peripherals of the product, is then stored in the database, as shown in the step 100 in FIG. 1. Each customer order will be assigned an order number which is unique. The rule for generating the order number can be different based on difference of the system designs. However, the order number must represent the sequence of orders generated and received by the system in order to prevent the orders from duplication.

According to the time period set by the system, the converting management program will be executed following the time period to convert the customer order information stored in the order receiving system into the data of production order needed by the assembling production line, as shown in the step 102 in FIG. 1. After the conversion of the information is completed, a converting remark is added to the customer order by the converting management program. The execution frequency for the converting management program can be adjusted according to the actual situation of the receiving frequency from the order receiving system or the production situation on the assembling production line.

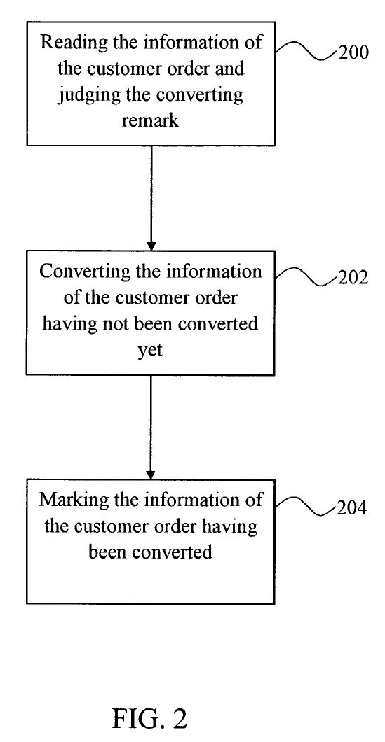

As shown in FIG. 2, it is a flow diagram, schematically illustrating the process flow for the converting management program to convert the information of the customer order stored into the data of a production order, according to the preferred embodiment of the present invention. When the converting management program starts to be executed, the customer orders are sequentially converted into the data of the production order needed by the assembling production line according to the sequence of the order numbers. As the converting management program is executing, the information of customer orders received by the order receiving system is read from the database, the converting remark is checked before converting the information of the customer order into the data of production order, as shown in the step 200 in FIG. 2. If no converting remark is existed, the conversion of the information of the customer order is executed. If a converting remark is existed, the order will be skipped, as shown in the step 202 in FIG. 2. When a customer order information has been converted, a converting remark for this customer order is marked in order to prevent the conversion of the customer order from duplicate, as shown in the step 204 in FIG. 2. The converted data of the production order at least is includes a unique production order number, unique product serial numbers, and a production remark. In this preferred embodiment, the production order serial number is the same as the customer order number. In this manner, the information of customer order is uniquely corresponding to the data of production order information respectively. Any method for showing the correspondence between the customer order number and production order number can be used. The product serial number is unique and corresponding to the production order serial number. The product serial number is provided to the assembling production line for manufacture use. However, the rule for generating these serial numbers can be different, according to the actual design of the system for the production flow on the assembling production line. The production remark on this production order indicates whether or not it has been arranged into the assembling production line for production. In this manner, it can prevent the situations of duplicate productions or no production at all from occurring.

After being converted, the information of the product serial number can be transmitted to the assembling production line in a hardcopy format or in an electronic format. In this embodiment, the product serial number is in a hardcopy format which is printed out as a production travel card. The production travel card bears the production order number, product serial number and the information of the related product parts needed, wherein each item of information is preferably printed as a barcode. Other methods can be used to record the necessary information. The first station of the assembling production line is a picking station for the parts. This picking station has at least a storage rack, which is coupled with the control system for picking out the part items, in which the rack has a plurality of storage spaces and each storage space is equipped with an indicating device. The indicating device can be a LED, a lamp, or any light emitting devices commonly known to the skilled in the art. Furthermore, each storage space is only for one unique part. The operator at the picking station uses the reading device to read out the information of the product travel card, including the production serial number, the quantity of the products, the part information of the products and the related information. The control system responds to the input production data to drive the indicating devices to show the storage locations on the rack of the needed parts of the products to be assembled. In addition, if the storage space is out of parts, the indicating device will alarm to remind the operators to fill the parts. According to the indication of the indicating devices on the storage rack, the operators can pick up the accurate parts for the products to be assembled.

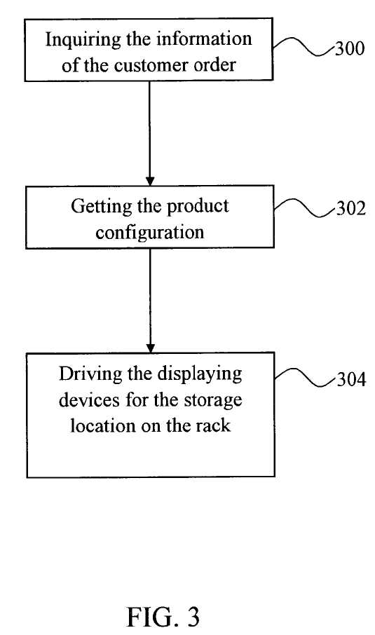

As shown in FIG. 3, it is a flow diagram, schematically illustrating the process flow for the control system for responding to the data of the production orders converted from customer orders, according to the preferred embodiment of the present invention. The control system responds to the input data to inquire the customer order information, as shown in step 300 of FIG. 3. According to the information of the customer order and the production order, the configuration of the products is identified, such as the quantity of the products, the requested peripherals thereof and the needed parts, as shown in the step 302 in FIG. 3. Next, the control system, according to the product configuration and the information stored in the system about the parts, gets the information of the storage locations on the rack. Then, the indicating devices with respect to the storage locations of the related product parts on the rack are driven to mark out the needed product parts, as shown in the step 304 in FIG. 3. The method for driving the indicating devices on the storage rack in the control system may be different, according to the different manner of connecting the storage rack. Usually, it is performed according to the specifications of the rack made by the manufacturer.

The order receiving system of the present invention can also receive the information of an electronic order transmitted from the other system via a connection to that other system. The electronic order information can also be similarly processed by the converting management program to be converted into the information of the production order needed by the assembling production line.

The present invention has disclosed a system for systematic production after receiving the customer order, which can effectively simplify the production flow in assembling flow. Also, the repetitious entering of data can be reduced, and the erroneous data can be prevented. This system helps the operator on the production line to pick the part items correctly.

The present invention uses the converting management program to automatically convert the information of the customer order into the data of the production order which can be used by the assembling production line. It can effectively simplify the process flow and improve the efficiency in processing the customer order. Also, the control system for picking out the part items is used to drive the displaying devices installed on the rack with respect to the storage locations, to mark out the locations of the product parts. This can also simplify the picking action for the part to the operator, so as to prevent the situation of picking the incorrect parts.

While the invention has been described by way of example and in terms of a preferred embodiment, it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. A system for systematic production of information products, comprising:
an order receiving system for receiving customers' orders;
a converting management program for converting the information of the customer orders into the data requested by a production line; and
an assembling production line equipped with at least one storage rack, wherein the storage rack has a plurality of storage spaces for storing the parts of the information products and each storage space is equipped with an indicating device, and coupled with a control system for responding to the data converted from the converting management program by driving the indicating devices to show the locations of the parts on the rack for assembling the information products.

2. The system for systematic production of information products as recited in claim 1, wherein the converting management program is periodically executed in a fixed time period according to a time schedule to convert the customers' order into the data requested by the production line.

3. The system for systematic production of information products as recited in claim 1, wherein the indicating device includes a LED device.

4. The system for systematic production of information products as recited in claim 3, wherein the indicating device includes a warning lamp.

5. A method for systematic production of information products, comprising the steps of:
receiving the customer orders and storing the same in a database management system, wherein each order is assigned a unique serial order number; and
converting the information of the customer orders into the data requested by a production line by a converting management program;
wherein the converting management program will mark the converted customers' order after the same has been converted.

6. The method for systematic production of information products as recited in claim 5, wherein the database management system is a relational database management system.

7. The method for systematic production of information products as recited in claim 5, wherein the converting management program is periodically executed at a fixed period of time.

8. The method for systematic production of information products as recited in claim 5, wherein the step of converting the information of the customer orders into the data requested by a production line by a converting management program is performed in sequence one by one.

9. The method for systematic production of information products as recited in claim 5, wherein the step of converting the information of the customer orders into the data requested by a production line by a converting management program is performed by a batch.
